(19) United States
(12) Patent Application Publication
(10) Pub. No.: US 2024/0375143 A1
(43) Pub. Date: Nov. 14, 2024

(54) COATING DIE AND COATING DEVICE

(71) Applicant: Panasonic Intellectual Property Mangement Co., Ltd., Osaka (JP)

(72) Inventors: Keisuke WAKIYA, Osaka (JP); Yudai AKIMOTO, Osaka (JP); Motoki KINUGAWA, Osaka (JP); tAKAO KUROMIYA, Osaka (JP)

(21) Appl. No.: 18/286,083

(22) PCT Filed: Mar. 11, 2022
(86) PCT No.: PCT/JP2022/011087

§ 371 Date: Oct. 6, 2023

(30) Foreign Application Priority Data
Apr. 9, 2021 (JP) 2021-066745

(51) Int. Cl. B05C 5/02; H01M 4/04

(52) U.S. Cl. CPC B05C 5/027; H01M 4/0404

(57) ABSTRACT

A coating die includes a manifold, a discharge port, and a rotating body rotatably accommodated in the manifold, an outer surface of the rotating body and an inner surface of the manifold being capable of forming a first slit. The manifold, the discharge port, and the rotating body are elongated in a first direction intersecting a discharge direction of the paint. The rotating body is rotatable about a rotational axis, has a long circumferential portion having a predetermined first length in the outer surface, and has a short circumferential portion having a second length shorter than the first length at a position in the outer surface displaced from the long circumferential portion, the long circumferential portion forming the first slit longer than the first slit formed by the short circumferential portion.

### TECHNICAL FIELD

The present invention relates to coating dies and coating devices.

### BACKGROUND ART

With the spread of electric vehicles (EVs), hybrid vehicles (HVs), plug-in hybrid vehicles (PHVs), etc., shipment of secondary batteries has been increasing. In particular, shipment of lithium-ion secondary batteries is increasing. The main components of a general secondary battery are a positive electrode plate, a negative electrode plate, a separator, and an electrolytic solution. The electrode plate such as the positive electrode plate and the negative electrode plate has a structure in which an electrode active material is laminated on the surface of a current collector made of a metal foil. One method of manufacturing the electrode plate known in the related art is a method of using an intermittent coating device including a die that discharges an electrode slurry and an intermittent valve that switches between supply and non-supply of the electrode slurry to the die to coat a surface of an elongated current collector with the electrode slurry intermittently (see, for example, patent literature 1).

[Patent Literature 1] JP2010-108678

### SUMMARY OF INVENTION

### Technical Problem

The amount of electrode slurry discharged from the coating die may become uneven in the coating width direction. When the amount of electrode slurry discharged becomes uneven, the thickness of the electrode active material layer becomes uneven, and the performance of the secondary battery can be impaired. For this reason, the conventional coating die is provided with a plurality of choke bars arranged in the coating width direction. Each choke bar can advance to or recede from the flow path of the electrode slurry, and the amount of electrode slurry discharged can be adjusted in the coating width direction by adjusting the amount of protrusion of each choke bar.

However, even if the discharge amount is adjusted to be even in the preparation stage of a coating process, the dimension of the coating die or the viscosity of the electrode slurry may change with a temperature change so that the discharge amount may become uneven during the coating process. Conventionally, the choke bar has been manipulated every time the discharge amount becomes uneven to equalize the discharge amount.

The present disclosure addresses the issue described above, and a purpose thereof is to provide a technology designed to improve workability in a coating process.

### Solution to Problem

One aspect of the present disclosure relates to a coating die that applies a paint to a coated body. The coating die includes: a manifold that temporarily stores the paint; a discharge port that discharges the paint in the manifold toward the coated body; and a rotating body rotatably accommodated in the manifold and having an outer surface that faces an inner surface of the manifold, a gap between the inner surface and the outer surface being capable of forming a first slit through which the paint directed toward the discharge port passes. The manifold, the discharge port, and the rotating body are elongated in a first direction intersecting a discharge direction of the paint from the discharge port. The rotating body is rotatable about a rotational axis extending in the first direction, has a long circumferential portion having a predetermined first length in a circumferential direction of the rotational axis at a predetermined position in the outer surface, and has a short circumferential portion having a second length shorter than the first length in the circumferential direction of the rotational axis at a position in the outer surface displaced from the long circumferential portion in the first direction, the long circumferential portion forming the first slit longer than the first slit formed by the short circumferential portion.

Another aspect of the present disclosure relates to a coating device. The coating device includes: the coating die that applies a paint to a coated body according to the above aspect; and a supply device that supplies the paint to the coating die.

Optional combinations of the aforementioned constituting elements, and implementations of the invention in the form of methods, apparatuses, and systems may also be practiced as modes of the present invention.

### Advantageous Effects of Invention

According to the present disclosure, workability in the coating process can be improved.

### BRIEF DESCRIPTION OF DRAWINGS

FIG. 1 is a schematic diagram of a coating device according to an embodiment;

FIG. 2 is a perspective view of the coating die;

FIG. 3 is an exploded view of the coating die;

FIG. 4A is a perspective view of the rotating body;

FIG. 4B is a front view of the rotating body;

FIG. 4C is a plan view of the rotating body;

FIGS. 5A and 5B are perspective views of the coating die cut in the central portion in the first direction;

FIG. 6A is a perspective view of the coating die cut in the central portion in the first direction;

FIG. 6B is a perspective view of the coating die cut between the central portion in the first direction and the end;

FIG. 6C is a perspective view of the coating die cut at the end in the first direction;

FIG. 7A is a perspective view of the first block and the shim; and

FIG. 7B is a plan view of the first block and the shim.

### DESCRIPTION OF EMBODIMENTS

Hereinafter, the present disclosure will be described based on preferred embodiments with reference to drawings. The embodiments do not limit the scope of the present disclosure but exemplify the disclosure. Not all of the features and the combinations thereof described in the embodiments are necessarily essential to the present disclosure. Identical or like constituting elements, members, processes shown in the drawings are represented by identical symbols and a duplicate description will be omitted as appropriate. The scales and shapes shown in the figures are defined for convenience's sake to make the explanation easy and shall not be interpreted limitatively unless otherwise specified. Terms like “first”, “second”, etc. used in the specification and claims do not indicate an order or importance by any means unless otherwise specified and are used to distinguish a certain feature from the others. Those of the members that are not important in describing the embodiment are omitted from the drawings.

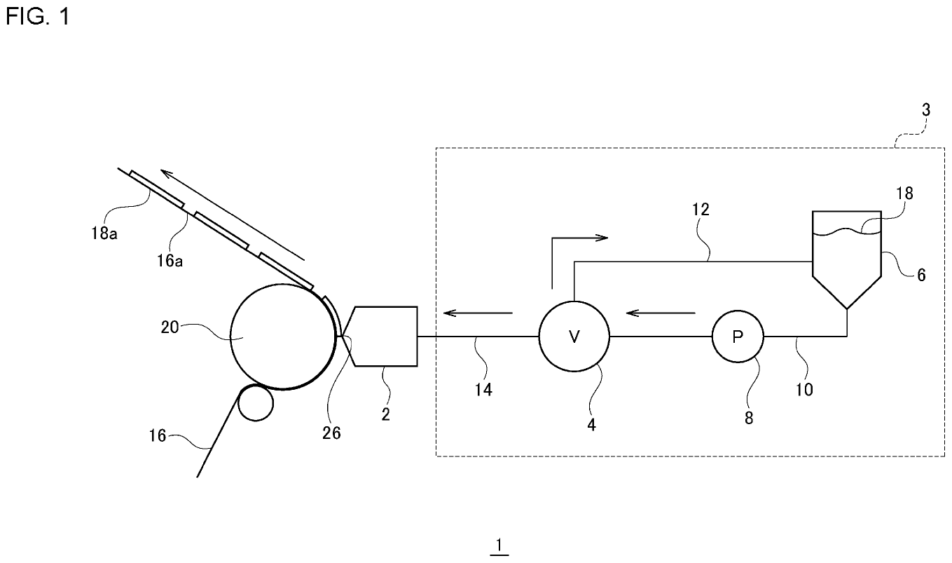

FIG. 1 is a schematic diagram of a coating device 1 according to an embodiment. The coating device 1 includes a coating die 2 and a supply device 3. The coating die 2 applies a paint 18 to a coated body 16. The coating device 1 according to this embodiment is used to manufacture an electrode plate of a secondary battery. The electrode plate of the secondary battery is a sheet-shaped electrode material produced by applying an electrode slurry to a current collector and drying the resultant product. In this embodiment, therefore, the coated body 16 is a current collector of a secondary battery, and the paint 18 is an electrode slurry of the secondary battery. The current collector is, for example, a metal foil. The electrode slurry is, for example, a mixture of a positive electrode active material or a negative electrode active material and a solvent, etc.

In the case of a general lithium ion secondary battery, the positive electrode plate is produced by coating an aluminum foil with a slurry containing a positive electrode active material such as lithium cobalt oxide, lithium iron phosphate, etc. The negative electrode plate is produced by coating a copper foil with a slurry containing a negative electrode active material such as graphite. The coating device 1 can also be used to manufacture articles other than the electrode plate.

The coating die 2 is arranged such that the discharge port 26 faces the circumferential surface of the backup roll 20 at a predetermined interval. The coated body 16 is continuously transported by the rotation of the backup roll 20 to a position where the backup roll 20 and the discharge port 26 face each other.

The supply device 3 supplies the paint 18 to the coating die 2. The supply device 3 of this embodiment includes an intermittent valve 4, a tank 6, a pump 8, a feed pipe line 10, a return pipe line 12, and a die supply pipe line 14. An intermittent valve 4 is connected to the coating die 2 via the die supply pipe line 14. The tank 6 is connected to the intermittent valve 4 via the feed pipe line 10 and the return pipe line 12. The tank 6 stores the paint 18. The pump 8 is provided in the feed pipe line 10, and the paint 18 is driven by the pump 8 to be fed from the tank 6 to the intermittent valve 4. The intermittent valve 4 supplies the paint 18 supplied from the tank 6 to the coating die 2 via the die supply pipe line 14. Or, the intermittent valve 4 returns the paint 18 supplied from the tank 6 to the tank 6 via the return pipe line 12.

As the intermittent valve 4 supplies the paint 18 to the coating die 2, the paint 18 can be discharged from the coating die 2, and a coated portion 18a coated with the paint 18 can be formed in the coated body 16. Further, as the intermittent valve 4 returns the paint 18 to the tank 6, the discharge of the paint 18 from the coating die 2 can be stopped, and an uncoated portion 16a not coated with the paint 18 can be formed in the coated body 16. That is, the intermittent valve 4 can intermittently coat the coated body 16 with the paint 18. The uncoated portion 16a is used for pasting the center lead of the electrode, etc. The coating performed by the coating device 1 is not limited to intermittent coating.

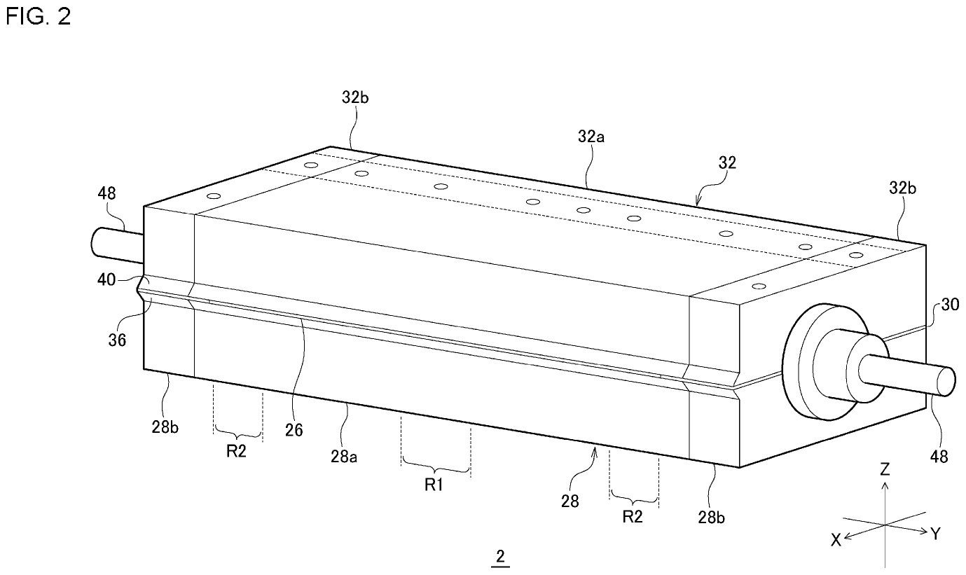

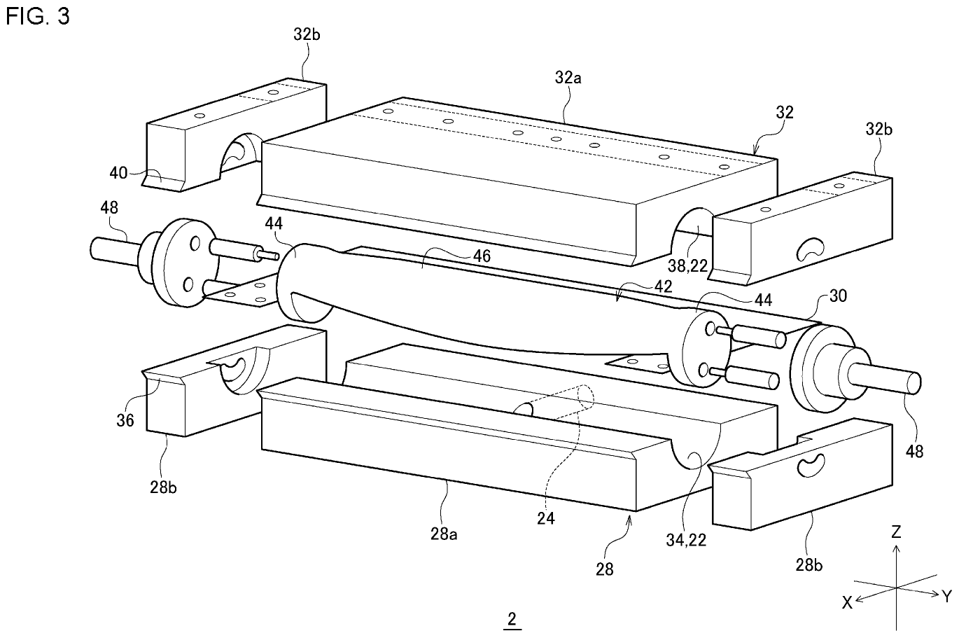

FIG. 2 is a perspective view of the coating die 2. FIG. 3 is an exploded view of the coating die 2. The coating die 2 includes a manifold 22, a supply port 24, and a discharge port 26. The manifold 22 temporarily stores the paint 18. The supply port 24 establishes communication between the manifold 22 and the space outside the coating die 2. The paint 18 is supplied to the manifold 22 via the supply port 24 from outside the coating die 2, i.e., from the supply device 3. The discharge port 26 discharges the paint 18 in the manifold 22 toward the coated body 16. Hereinafter, the direction in which the paint 18 is discharged from the discharge port 26 is defined as the discharge direction X.

The coating die 2 of this embodiment has a structure in which a first block 28, a shim 30 (deckle), and a second block 32 are stacked in this order. The first block 28, the shim 30, and the second block 32 are elongated in the first direction Y intersecting the discharge direction X and stacked in the second direction Z intersecting the discharge direction X and the first direction Y. In the present embodiment, the discharge direction X, the first direction Y, and the second direction Z intersect each other vertically. Further, the discharge direction X and the first direction Y are both horizontally extending directions, and the second direction Z is a vertically extending direction.

The first block 28 includes a central block 28a elongated in the first direction Y and a pair of end blocks 28b sandwiching the central block 28a in the first direction Y. Each end block 28b is connected to the central block 28a by a fastening member (not shown). The first block 28 is a flat, substantially rectangular parallelepiped and is arranged such that one main surface faces the second block 32. The first block 28 has a first recess 34 on the main surface facing the second block 32. The first recess 34 has a semi-cylindrical shape elongated in the first direction Y. The first block 28 has a first protrusion 36 protruding in the discharge direction X. The first protrusion 36 is arranged so as to be elongated in the first direction Y and flush with the main surface facing the second block 32. The central block 28a is provided with the supply port 24. One end of the supply port 24 is connected to the first recess 34. The other end of the supply port 24 is connected to the die supply pipe line 14. In this embodiment, the supply port 24 is disposed in the center of the first block 28 in the first direction Y.

The second block 32 includes a central block 32a elongated in the first direction Y and a pair of end blocks 32b sandwiching the central block 32a in the first direction Y. Each end block 32b is connected to the central block 32a by a fastening member (not shown). The second block 32 is a flat, substantially rectangular parallelepiped and is arranged such that one main surface faces the first block 28. The second block 32 has a second recess 38 on the main surface facing the first block 28. The second recess 38 has a semi-cylindrical shape elongated in the first direction Y. The diameter of the semicylinder of the second recess 38 is smaller than the diameter of the semicylinder of the first recess 34. The second recess 38 faces the first recess 34 in the second direction Z. The second block 32 has a second protrusion 40 that protrudes in the discharge direction X. The second protrusion 40 is arranged so as to be elongated in the first direction Y and flush with the main surface facing the first block 28. The second protrusion 40 faces the first protrusion 36 in the second direction z.

The shim 30 is a substantially U-shaped plate member that surrounds three sides of the first recess 34 except for the side toward the first protrusion 36 as seen in the second direction Z and three sides of the second recess 38 except for the side toward the second protrusion 40. The first block 28 and the second block 32 are fastened to each other by a fastening member (not shown) with the shim 30 sandwiched in the second direction Z. The fastening member connecting the first block 28 and the second block 32 is inserted into each block in an area overlapping the shim 30 when viewed in the second direction Z. Therefore, the first block 28 and the second block 32 are fastened to each other in three areas around the first recess 34 and the second recess 38 except for the areas toward the respective protrusions.

Since the shim 30 is disposed between the first block 28 and the second block 32, a gap defined by the thickness of the shim 30 is formed between the first protrusion 36 and the second protrusion 40. This gap constitutes the discharge port 26. The discharge port 26 is elongated in the first direction Y. Further, in a state in which the first block 28 and the second block 32 are fastened to each other, a substantially cylindrical space is formed by the first recess 34 and the second recess 38. This space constitutes the manifold 22. The manifold 22 is elongated in the first direction Y.

The coating die 2 has a first area R1 and a second area R2 displaced from each other in the first direction Y. In the absence of a first slit 52 described later, the first area R1 discharges the paint 18 in a predetermined first discharge amount. Meanwhile, the second area R2 discharges the paint 18 in a second discharge amount less than the first discharge amount. That is, the amount of the paint 18 discharged (amount discharged per unit time) by the coating die 2 varies in the first direction Y. One of the factors that cause the variation in discharge amount is the position of connection of the supply port 24 to the manifold 22. Generally, the discharge amount in an area in the coating die 2 including the supply port 24 tends to be large and to decrease as the distance from that area increases.

In this embodiment, the supply port 24 is connected to the central portion of the manifold 22 in the first direction Y. For this reason, the coating die 2 has the first area R1 characterized by a large discharge amount in the central portion in the first direction Y and has the second area R2 characterized by a small discharge amount at the ends in the first direction Y. Further, the ends of the first block 28 and the second block 32 in the first direction Y are fastened. For this reason, the discharge port 26 tends to be more open in the central portion than at the ends. This makes it more likely that the central portion in the first direction Y is the first area R1, and the ends in the first direction Y are the second areas R2.

The amount of the paint 18 discharged progressively decreases in a direction from the central portion in the first direction Y toward the ends. For this reason, an arbitrary first position in the first direction Y will be the first area R1, and a second position located closer to the end than the first position will be the second area R2. That is, the first area R1 is not limited to the central portion in the first direction Y, and the second area R2 is not limited to the ends in the first direction Y. However, the figures show the central portion as the first area R1 and the ends as the second areas R2 for convenience.

Further, as each block or the shim 30 expands or contracts with a temperature change, the dimension (openness) of the discharge port 26 could change. Further, the viscosity of the paint 18 could also change as the temperature of the paint 18 changes. When the dimension of the discharge port 26, the viscosity of the paint 18, or the like changes, the difference between the amount of the paint 18 discharged in the first area R1 and the amount of the paint 18 discharged in the second area R2 could also change. That is, the tendency of the variation in discharge amount in the first direction Y could change during the coating process.

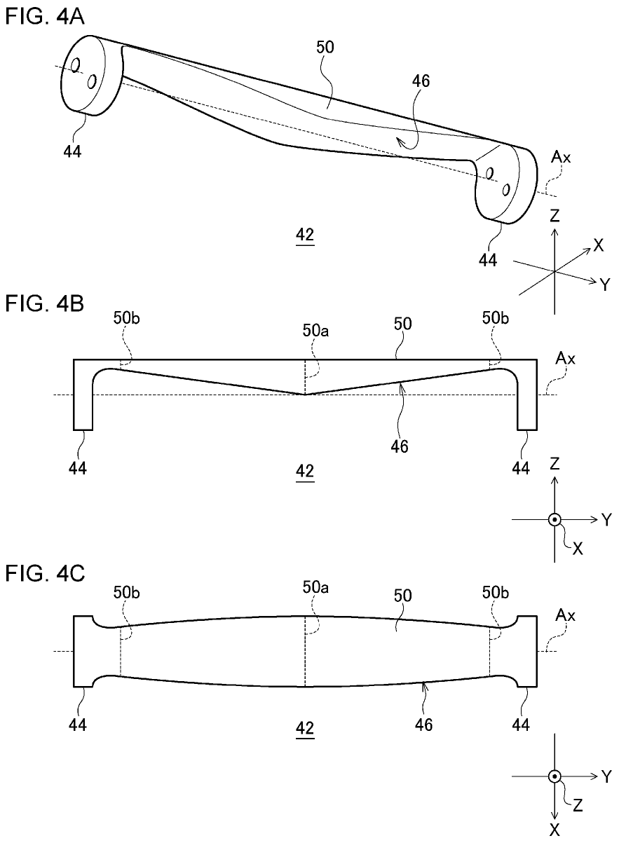

In order to suppress such variation in discharge amount, the coating die 2 includes a rotating body 42. FIG. 4A is a perspective view of the rotating body 42. FIG. 4B is a front view of the rotating body 42. FIG. 4C is a plan view of the rotating body 42. FIGS. 4A-4C illustrate the rotating body 42 in the reference attitude described later. The base shape of the rotating body 42 is a cylinder elongated in the first direction Y in which a part of the circumferential surface of the cylinder is cut out substantially over the entirety in first direction Y. The diameter of the cylinder is substantially equal to the diameter of the semicylinder of the second recess 38. The rotating body 42 has disk-shaped supports 44 at the ends in the first direction Y. Further, the rotating body 42 has a main body 46 that remains uncut between the pair of supports 44.

The rotating body 42 is rotatably accommodated in the manifold 22. The rotating body 42 is rotatable about a rotational axis Ax extending in the first direction Y. The rotational axis Ax corresponds to the central axis of the cylinder, which is the base shape of the rotating body 42. Each support 44 is fastened to a rotation control body 48 protruding outside the coating die 2 in the first direction Y (see FIGS. 2 and 3). Each rotation control body 48 can rotate about the rotational axis Ax. As the rotation control body 48 rotates, the rotating body 42 rotates about the rotational axis Ax.

The main body 46 has an outer surface 50. The outer surface 50 faces the inner surface of the manifold 22. The outer surface 50 corresponds to a portion of the circumferential surface of the cylinder that remains uncut. The thickness of the main body 46 is largest in the central portion in the first direction Y and progressively becomes smaller toward the ends in the first direction Y. For this reason, the length of the outer surface 50 in the circumferential direction of the rotational axis Ax varies depending on the position in the first direction Y. That is, the outer surface 50 has a long circumferential portion 50a having a predetermined first length in the circumferential direction of the rotational axis Ax at a predetermined position in the first direction Y and has a short circumferential portion 50b having a second length shorter than the first length in the circumferential direction of the rotational axis Ax at a position displaced from the long circumferential portion 50a in the first direction Y. The first length and the second length can be appropriately set based on experiments and simulations.

The rotating body 42 of this embodiment has the long circumferential portion 50a in a portion in the outer surface 50 included in the first area R1 and has the short circumferential portion 50b in a portion in the outer surface 50 included in the second area R2. In the rotating body 42 of this embodiment, the position of the long circumferential portion 50a in the first direction Y overlaps the position of the supply port 24 in the first direction Y. The positions of the long circumference portion 50a and the supply port 24 in the first direction Y may overlap at least in part. Preferably, the centers of the long circumferential portion 50a and the supply port 24 in the first direction Y coincide. The long circumferential portion 50a is disposed in the central portion of the rotating body 42 in the first direction Y, and the short circumferential portion 50b is disposed at the ends of the rotating body 42 in the first direction Y.

The position of the long circumferential portion 50a is not limited to the central portion in the first direction Y, and the position of the short circumferential portion 50b is not limited to the ends in the first direction Y. That is, the outer surface 50 may have the long circumferential portion 50a at an arbitrary first position in the first direction Y and have the short circumferential portion 50b at a second position closer to the end than the first position. However, the figures show the central portion of the outer surface 50 as the long circumferential portion 50a and the ends as the short circumferential portions 50b for convenience. In this embodiment, the length of the outer surface 50 in the circumferential direction of the rotational axis Ax progressively decreases in a direction from the long circumferential portion 50a toward the short circumferential portion 50b.

Further, the shape of the rotating body 42 can be changed appropriately according to the arrangement of the first area R1 and the second area R2. For example, the rotating body 42 may have a shape in which the length in the circumferential direction of the rotational axis Ax is short in the central portion and long at the ends. Alternatively, the rotating body 42 may be shaped such that the length is largest at one end in the first direction Y and is progressively smaller toward the other end. Alternatively, a plurality of alternate long and short portions may be arranged in the first direction Y.

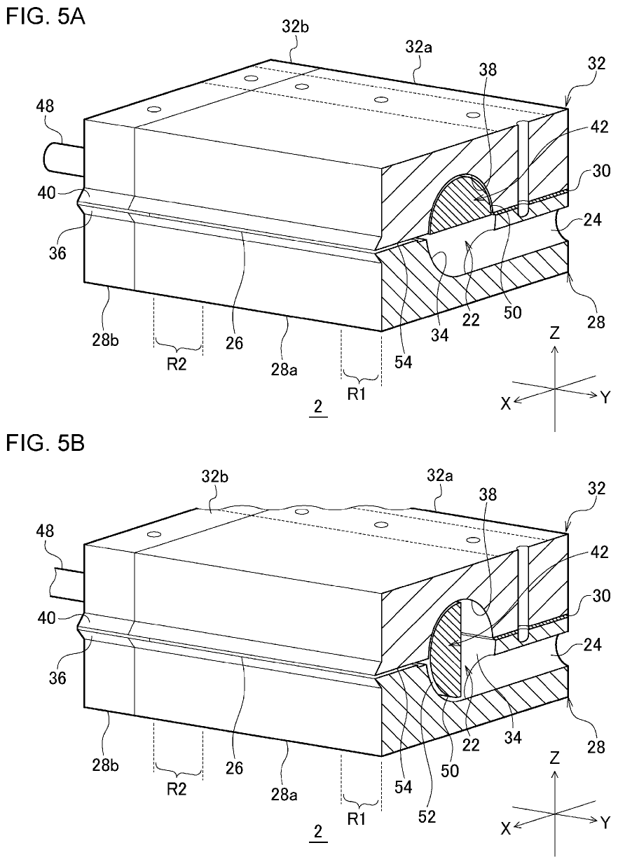

FIGS. 5A and 5B are perspective views of the coating die 2 cut in the central portion in the first direction Y. As shown in FIG. 5A, the rotating body 42 can be placed in a state in which the main body 46 is accommodated in the second recess 38. Hereinafter, it is defined that the rotation angle of the rotating body 42 in this state is 0° and the rotating body 42 is in a reference attitude when the rotation angle is 0°. As shown in FIG. 5B, the rotating body 42 can rotate from the reference attitude to a predetermined angle in a direction in which the front end thereof in the discharge direction X enters the side of the first recess 34. The rotating body 42 of this embodiment can rotate up to 90° from the reference attitude.

As described above, the diameter of the semicylinder of the first recess 34 is larger than the diameter of the semicylinder of the second recess 38. Further, the diameter of the cylinder, which is the base shape of the rotating body 42, is substantially equal to the diameter of the semicylinder of the second recess 38. When the rotating body 42 is in the reference attitude, therefore, the outer surface 50 is in contact with the inner surface of the second recess 38. Further, when the rotating body 42 rotates from the reference attitude and the outer surface 50 and the inner surface of the first recess 34 face each other, a gap is created between the outer surface 50 and the inner surface of the first recess 34. This gap constitutes the first slit 52. The paint 18 in the manifold 22 passes through the first slit 52 and is directed toward the discharge port 26. By forming the first slit 52 between the manifold 22 and the discharge port 26, the flow resistance of the paint 18 can be increased, and thus the amount of the paint 18 discharged can be reduced.

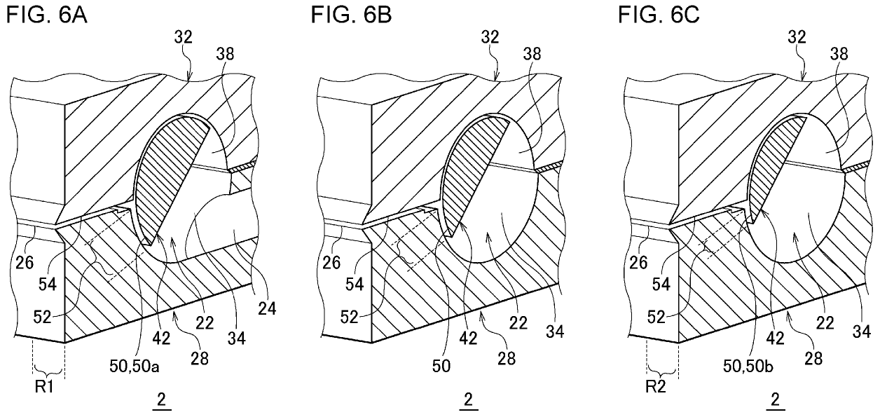

FIG. 6A is a perspective view of the coating die 2 cut in the central portion in the first direction Y. FIG. 6B is a perspective view of the coating die 2 cut between the central portion in the first direction Y and the end. FIG. 6C is a perspective view of the coating die 2 cut at the end in the first direction Y. FIGS. 6A-6C illustrate the rotating body 42 rotated 45° from the reference attitude.

The outer surface 50 of the rotating body 42 has the long circumferential portion 50a and the short circumferential portion 50b. As the rotating body 42 is rotated from the reference posture, the long circumferential portion 50a begins to enter the first recess 34 before the short circumferential portion 50b. For this reason, the length of the first slit 52 is longer in the long circumferential portion 50a and shorter in the short circumferential portion 50b as shown in FIGS. 6A and 6C. The length of the outer surface 50 of this embodiment progressively decreases in a direction from the central portion toward the ends in the first direction Y. For this reason, the length of the first slit 52 becomes progressively shorter in a direction from the central portion toward the ends in the first direction Y as shown in FIGS. 6A-6C.

The rotating body 42 has the long circumferential portion 50a in the first area R1 and the short circumferential portion 50b in the second area R2. Therefore, the rotating body 42 can form the first slit 52 that is longer in the first area R1 than in the second area R2. The longer the first slit 52, the greater the flow resistance and the smaller the flow rate of the paint 18 until it passes through the first slit 52. By forming the first slit 52 as described above, therefore, the amount of the paint 18 discharged can be reduced in a large amount in the first area R1, where the amount of the paint 18 discharged is large in the absence of the first slit 52. Further, the amount of the paint 18 discharged can be reduced in a small amount in the second area R2, where the amount of the paint 18 discharged is small in the absence of the first slit 52. As a result, the amount of the paint 18 discharged can be equalized in the first area R1 and in the second area R2.

Further, the length of the first slit 52 in the first area R1 and in the second area R2 can be changed simply by changing the rotation angle of the rotating body 42. Further, as shown in FIG. 4C, the ridge line (outline) of the outer surface 50 extending in the first direction Y is curved. That is, the amount of reduction of the outer surface 50 in a direction from the central portion toward the ends in the first direction Y is not uniform. For this reason, the length of the first slit 52 can be increased or decreased by amounts of change different between the first area R1 and the second area R2, by changing the rotation angle of the rotating body 42. Therefore, the amount of the paint 18 discharged from the first area R1 and from the second area R2 can be easily adjusted. Thereby, even if the tendency of the variation in discharge amount in the first direction Y changes during the coating process due to a change in the dimension of the discharge port 26 or the viscosity of the paint 18, the discharge amount can be easily equalized.

The rotation angle of the rotating body 42 can be adjusted by manipulating the rotation control body 48. The rotation control body 48 may be manipulated manually by an operator or may be driven by a drive device (not shown) such as a motor. Alternatively, a known flow meter installed at the discharge port 26 and a drive device may be combined to subject the rotation angle of the rotating body 42 to feedback control.

Further, the coating die 2 has a second slit 54 through which the paint 18 directed from the manifold 22 toward the discharge port 26 passes. The second slit 54 is connected to the first slit 52 at one end and is connected to the discharge port 26 at the other end. The paint 18 fed from the supply device 3 flows into the manifold 22 from the supply port 24. The paint 18 is temporarily accumulated in the manifold 22 and then passes through the first slit 52 and the second slit 54 in this order to reach the discharge port 26, before being discharged from the discharge port 26. By temporarily accumulating the paint 18 in the manifold 22 and then feeding it to the discharge port 26, the stability of the paint 18 discharged can be increased.

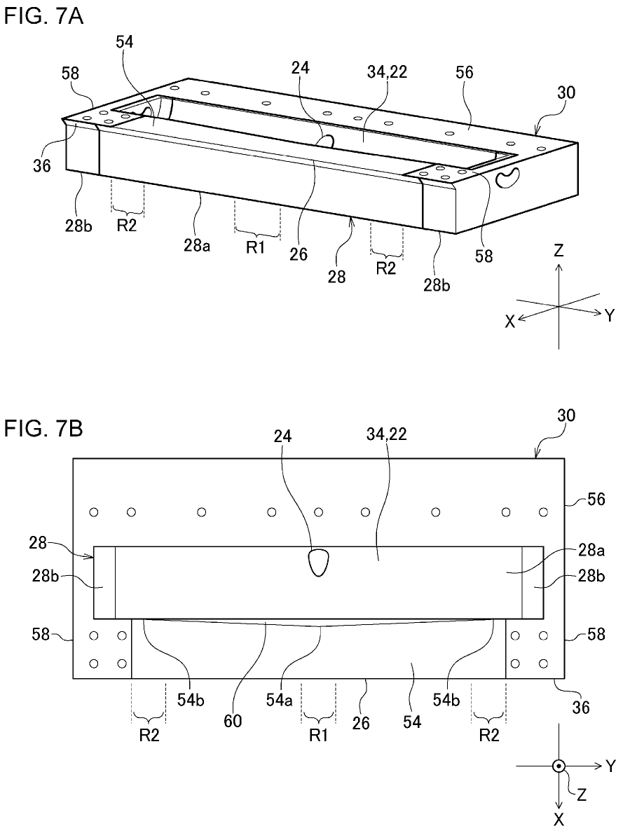

The second slit 54 is formed by the first block 28, the shim 30 and the second block 32. FIG. 7A is a perspective view of the first block 28 and the shim 30. FIG. 7B is a plan view of the first block 28 and the shim 30.

As shown in FIGS. 7A and 7B, the shim 30 is cut in an area overlapping the manifold 22 when viewed in the second direction Z and in an area from the manifold 22 to the discharge port 26. Thus, the shim 30 has a main body 56 extending along the edge of the manifold 22 opposite to the discharge port 26 and a pair of arms 58 protruding from the ends of the main body 56 in the first direction Y toward the discharge port 26. The second slit 54 is formed by the central block 28a of the first block 28 and the central block 32a of the second block 32 that face each other in the second direction Z and by the pair of arms 58 that face each other in the first direction Y. The second slit 54 is elongated in the first direction Y.

The second slit 54 has a small resistance portion 54a that generates a predetermined first flow resistance in the paint 18 and a large resistance portion 54b that generates a second flow resistance larger than the first flow resistance in the paint 18. The magnitude of the first flow resistance and the second flow resistance can be appropriately set based on experiments and simulations. The first block 28 of this embodiment has a trench portion 60 recessed in the second direction Z in an area between the first recess 34 and the first protrusion 36. The trench portion 60 extends in the first direction Y along the edge of the first recess 34 toward the discharge port 26. Further, when viewed in the second direction Z, the trench portion 60 has a shape of a triangle, in which the base is the edge of the first recess 34 and the apex angle protrudes toward the discharge port 26.

The flow path cross-sectional area is large in a portion of the second slit 54 where the trench portion 60 is provided. As the flow path cross-sectional area increases, the flow resistance of the paint 18 decreases. Further, the larger the length of the trench portion 60 occupying the flow path of the paint 18 extending from the manifold 22 in the discharge direction X, the smaller the flow resistance of the paint 18. Therefore, the portion in the second slit 54 including the apex angle of the trench portion 60 will be the small resistance portion 54a, and the portion including the base angle of the trench portion 60 will be the large resistance portion 54b.

In the second slit 54 of this embodiment, the apex angle of the trench portion 60 is located in the central portion in the first direction Y. Further, the base angles of the trench portion 60 are located at the ends in the first direction Y. Therefore, the small resistance portion 54a is provided in a position corresponding to the first area R1, and the large resistance portion 54b is provided in a position corresponding to the second area R2. In the absence of the first slit 52, the second slit 54 ensures that the amount of the paint 18 discharged is larger in the first area R1 and smaller in the second area R2.

By forming the first slit 52, the rotating body 42 changes the degree in which the amount of the paint 18 discharged is reduced to equalize the variation in the discharge amount in the first direction Y. Further, the second slit 54 can increase the difference between the first discharge amount and the second discharge amount. By increasing the difference between the first discharge amount and the second discharge amount, the range of rotation angle that can be formed by the rotating body 42 to equalize the discharge amount can be expanded. Therefore, the amplitude of discharge amount adjustment by the rotating body 42 can be expanded. It is also possible to create a state in which the rotating body 42 can equalize the discharge amount more reliably.

The first area R1 may be formed in the coating die 2 by providing the small resistance portion 54a, and the second area R2 may be formed in the coating die 2 by providing the large resistance portion 54b. In other words, the positions of the first area R1 and the second area R2 may be arbitrarily set in accordance with the arrangement of the small resistance portion 54a and the large resistance portion 54b. Thereby, the positions of the first area R1 and the second area R2 can be arbitrarily set according to the arrangement of the long circumferential portion 50a and the short circumferential portion 50b.

The position of the small resistance portion 54a is not limited to the central portion in the first direction Y, and the position of the large resistance portion 54b is not limited to the ends in the first direction Y. That is, the second slit 54 may have the small resistance portion 54a at an arbitrary first position in the first direction Y and have the large resistance portion 54b at a second position closer to the end than the first position. However, the figures show, for convenience, the central portion of the second slit 54 as the small resistance portion 54a and the ends as the large resistance portions 54b. In this embodiment, the length of the trench portion 60 occupying the flow path of the paint 18 progressively decreases in a direction from the central portion in the first direction Y toward the ends. Further, the trench portion 60 may be provided in the second block 32 or may be provided in both the first block 28 and the second block 32.

As described above, the coating die 2 of this embodiment includes a manifold 22 that temporarily stores the paint 18, a discharge port 26 that discharges the paint 18 in the manifold 22 toward the coated body 16, a rotating body 42 rotatably accommodated in the manifold 22 and having an outer surface 50 that faces the inner surface of the manifold 22, a gap between the inner surface and the outer surface 50 being capable of forming a first slit 52 through which the paint 18 directed toward the discharge port 26 passes. The manifold 22, the discharge port 26, and the rotating body 42 are elongated in the first direction Y intersecting the discharge direction X of the paint 18 from the discharge port 26.

The rotating body 42 is rotatable about a rotational axis Ax extending in the first direction Y, has a long circumferential portion 50a having a predetermined first length in the circumferential direction of the rotational axis Ax at a predetermined position in the outer surface 50, and has a short circumferential portion 50b having a second length shorter than the first length in the circumferential direction of the rotational axis Ax at a position in the outer surface 50 displaced from the long circumferential portion 50a in the first direction Y. The long circumferential portion 50a of the rotating body 42 forms a first slit 52 longer than the first slit 52 formed by the short circumferential portion 50b.

Thus, unevenness in coating by the coating die 2 can be canceled by using the rotating body 42 to form the first slit 52 having different lengths at positions displaced in the first direction Y. Thereby, the amount of the paint 18 discharged can be equalized in the discharge width direction. Therefore, the film thickness of the coated portion 18a can be equalized in the width direction, and the performance of the secondary battery can be enhanced. Further, the length of the first slit 52 in the respective regions arranged in the first direction Y can be changed simply by changing the rotation angle of the rotating body 42. Therefore, the amount of the paint 18 discharged from the respective areas can be adjusted easily. For this reason, workability in the coating process can be improved.

Further, the coating die 2 of this embodiment includes a first area R1 that discharges the paint 18 in a predetermined first discharge amount and a second area R2 that is displaced from the first area R1 in the first direction Y and discharges the paint 18 in a second discharge amount less than the first discharge amount in the absence of the first slit 52. The rotating body 42 has a long circumferential portion 50a in a portion in the outer surface 50 included in the first area R1 and a short circumferential portion 50b in a portion in the outer surface 50 included in the second area R2. This can cancel the difference in the amounts of the paint 18 discharged in the first area R1 and in the second area R2.

Further, the coating die 2 includes a supply port 24 that supplies the paint 18 to the manifold 22 from outside. The position of the long circumferential portion 50a in the first direction Y overlaps the position of the supply port 24 in the first direction Y. In general, the coating die 2 tends to discharge more of the paint 18 from an area at a position in the first direction Y overlapping the supply port 24. For this reason, unevenness in coating can be eliminated more effectively by aligning the position of the long circumferential portion 50a in the first direction Y with the supply port 24.

Further, the long circumferential portion 50a of this embodiment is disposed in the central portion of the rotating body 42 in the first direction Y. Generally, the ends of the first block 28 and the second block 32 in the first direction Y are fastened. Therefore, the coating die 2 tends to discharge more of the paint 18 from the central portion in the first direction Y. For this reason, unevenness in coating can be eliminated more effectively by arranging the long circumferential portion 50a in the central portion in the first direction Y.

Further, the coating die 2 of this embodiment has a second slit 54 through which the paint 18 directed from the manifold 22 toward the discharge port 26 passes. The second slit 54 has a small resistance portion 54a that corresponds to the first area Rl and generates a predetermined first flow resistance in the paint 18 and a large resistance portion 54b that corresponds to the second area R2 and generates a second flow resistance larger than the first flow resistance in the paint 18. Thereby, a state in which the rotating body 42 can perform its function more effectively or more reliably can be created.

The embodiments of the present disclosure are described above in detail. The embodiments described above are merely specific examples of practicing the present disclosure. The details of the embodiments shall not be construed as limiting the technical scope of the present disclosure. A number of design modifications such as modification, addition, deletion, etc. of constituting elements may be made to the extent that they do not depart from the idea of the present disclosure defined by the claims. New embodiments with design modifications will provide the combined advantages of the embodiment and the variation. Although the details subject to such design modification are emphasized in the embodiment described above by using phrases such as “of this embodiment” and “in this embodiment”, details not referred to as such are also subject to design modification. Any combination of the above constituting elements is also useful as a mode of the present disclosure. Hatching in the cross section in the drawings should not be construed as limiting the material of the hatched object.

The embodiments may be defined by the following items.

[Item 1] A coating die (2) that applies a paint (18) to a coated body (16), including:
a manifold (22) that temporarily stores the paint (18);
a discharge port (26) that discharges the paint (18) in the manifold (22) toward the coated body (16); and
a rotating body (42) rotatably accommodated in the manifold (22) and having an outer surface (50) that faces an inner surface of the manifold (22), a gap between the inner surface and the outer surface (50) being capable of forming a first slit (52) through which the paint (18) directed toward the discharge port (26) passes, wherein
the manifold (22), the discharge port (26), and the rotating body (42) are elongated in a first direction (Y) intersecting a discharge direction (X) of the paint (18) from the discharge port (26), and
the rotating body (42) is rotatable about a rotational axis (Ax) extending in the first direction (Y), has a long circumferential portion (50a) having a predetermined first length in a circumferential direction of the rotational axis (Ax) at a predetermined position in the outer surface (50), and has a short circumferential portion (50b) having a second length shorter than the first length in the circumferential direction of the rotational axis (Ax) at a position in the outer surface (50) displaced from the long circumferential portion (50a) in the first direction (Y), the long circumferential portion (50a) forming the first slit (52) longer than the first slit (52) formed by the short circumferential portion (50b).

[Item 2] The coating die (2) according to item 1, wherein the coating die (2) includes a first area (R1) that discharges the paint (18) in a predetermined first discharge amount in the absence of the first slit (52) and a second area (R2) that is displaced from the first area (R1) in the first direction (Y) and discharges the paint (18) in a second discharge amount less than the first discharge amount in the absence of the first slit (52), and
the rotating body (42) has the long circumferential portion (50a) in a portion in the outer surface (50) included in the first area (R1) and has the short circumferential portion (50b) in a portion in the outer surface (50) included in the second area (R2).

[Item 3] The coating die (2) according to item 1 or 2, including: a supply port (24) that supplies the paint (18) to the manifold (22) from outside, and
a position of the long circumferential portion (50a) in the first direction (Y) overlaps a position of the supply port (24) in the first direction (Y).

[Item 4] The coating die (2) according to any one of items 1 to 3, wherein the long circumferential portion (50a) is disposed in a central portion of the rotating body (42) in the first direction (Y).

[Item 5] The coating die (2) according to any one of items 1 to 4, wherein the coating die (2) includes a first area (R1) that discharges the paint (18) in a predetermined first discharge amount in the absence of the first slit (52) and a second area (R2) that is displaced from the first area (R1) in the first direction (Y) and discharges the paint (18) in a second discharge amount less than the first discharge amount in the absence of the first slit (52),
the coating die (2) also has a second slit (54) through which the paint (18) directed from the manifold (22) toward the discharge port (26) passes, and
the second slit (54) has a small resistance portion (54a) that corresponds to the first area (R1) and generates a predetermined first flow resistance in the paint (18) and a large resistance portion (54b) that corresponds to the second area (R2) and generates a second flow resistance larger than the first flow resistance in the paint (18).

[Item 6] The coating die (2) according to any one of items 1 to 5, wherein the coated body (16) is a current collector of a secondary battery, and
the paint (18) is an electrode slurry of the secondary battery.

[Item 7] A coating device (1) including: the coating die that applies a paint (18) to a coated body (16) according to any one of items 1 to 6; and
a supply device (3) that supplies the paint (18) to the coating die (2).

### INDUSTRIAL APPLICABILITY

The present invention can be used in coating dies and coating devices.

### REFERENCE SIGNS LIST

1 coating device, 2 coating die, 3 supply device, 16 coated body, 18 paint, 22 manifold, 24 supply port, 26 discharge port, 42 rotating body, 50 outer surface, 50a long circumferential portion, 50b short circumferential portion, 52 first slit, 54 second slit, 54a small resistance portion, 54b large resistance portion, Ax rotational axis, R1 first area, R2 second area, X discharge direction, Y first direction

1. A coating die that applies a paint to a coated body, comprising:
a manifold that temporarily stores the paint;
a discharge port that discharges the paint in the manifold toward the coated body; and
a rotating body rotatably accommodated in the manifold and having an outer surface that faces an inner surface of the manifold, a gap between the inner surface and the outer surface being capable of forming a first slit through which the paint directed toward the discharge port passes, wherein
the manifold, the discharge port, and the rotating body are elongated in a first direction intersecting a discharge direction of the paint from the discharge port, and
the rotating body is rotatable about a rotational axis extending in the first direction, has a long circumferential portion having a predetermined first length in a circumferential direction of the rotational axis at a predetermined position in the outer surface, and has a short circumferential portion having a second length shorter than the first length in the circumferential direction of the rotational axis at a position in the outer surface displaced from the long circumferential portion in the first direction, the long circumferential portion forming the first slit longer than the first slit formed by the short circumferential portion.

2. The coating die according to claim 1, wherein
the coating die includes a first area that discharges the paint in a predetermined first discharge amount in the absence of the first slit and a second area that is displaced from the first area in the first direction and discharges the paint in a second discharge amount less than the first discharge amount in the absence of the first slit, and
the rotating body has the long circumferential portion in a portion in the outer surface included in the first area and has the short circumferential portion in a portion in the outer surface included in the second area.

3. The coating die according to claim 1, comprising:
a supply port that supplies the paint to the manifold from outside, and
a position of the long circumferential portion in the first direction overlaps a position of the supply port in the first direction.

4. The coating die according to claim 1, wherein
the long circumferential portion is disposed in a central portion of the rotating body in the first direction.

5. The coating die according to claim 1, wherein
the coating die includes a first area that discharges the paint in a predetermined first discharge amount in the absence of the first slit and a second area that is displaced from the first area in the first direction and discharges the paint in a second discharge amount less than the first discharge amount in the absence of the first slit,
the coating die also has a second slit through which the paint directed from the manifold toward the discharge port passes, and
the second slit has a small resistance portion that corresponds to the first area and generates a predetermined first flow resistance in the paint and a large resistance portion that corresponds to the second area and generates a second flow resistance larger than the first flow resistance in the paint.

6. The coating die according to claim 1, wherein
the coated body is a current collector of a secondary battery, and
the paint is an electrode slurry of the secondary battery.

7. A coating device comprising:
the coating die that applies a paint to a coated body according to claim 1; and
a supply device that supplies the paint to the coating die.
